(19) United States
(12) Patent Application Publication
(10) Pub. No.: US 2016/0012858 A1
(43) Pub. Date: Jan. 14, 2016

(54) VIDEO FILE CREATION DEVICE AND VIDEO FILE CREATION METHOD

(71) Applicant: KABUSHIKI KAISHA TOSHIBA, Minato-ku (JP)

(72) Inventor: Yuki KAMIJIMA, Tokyo (JP)

(73) Assignee: KABUSHIKI KAISHA TOSHIBA, Minato-ku (JP)

(21) Appl. No.: 14/800,116

(22) Filed: Jul. 15, 2015

Related U.S. Application Data
(63) Continuation of application No. 13/194,394, filed on Jul. 29, 2011, now abandoned.

(30) Foreign Application Priority Data
Sep. 14, 2010 (JP) 2010-205802
Jul. 6, 2011 (JP) 2011-150333

(51) Int. Cl. G11B 27/32; H04N 9/804; H04N 5/76

(52) U.S. Cl. CPC G11B 27/32; H04N 5/76; H04N 9/8042

(57) ABSTRACT

A video file creation device according to an embodiment includes an encoder, a metadata acquisition unit, a file creation unit, and a data storage unit. The encoder is configured to create compressed video data from a video stream. The metadata acquisition unit is configured to acquire metadata related to the video data. The file creation unit configured to create a file in an MXF format having a metadata section formed of a metadata recording area and an additional writing area. The acquired metadata is recorded in the metadata recording area. The data storage unit configured to record the file in the MXF format created by the file creation unit.

### CROSS-REFERENCE TO RELATED APPLICATION

This continuation application is based upon and claims the benefit of priority under 35 U.S.C. §120 from U.S. application Ser. No. 13/194,394, filed Jul. 29, 2011, which claims the benefit of priority from prior Japanese Patent Application No. 2010-205802, filed on Sep. 14, 2010, and the prior Japanese Patent Application No. 2011-150333, filed on Jul. 6, 2011, the entire contents of which are incorporated herein by reference.

### FIELD

Embodiments of the present invention relate to a video file creation device and a video file creation method.

### BACKGROUND

In the broadcasting industry, in order to manage video data of the contents of recorded programs, metadata related to the video data is stored together with the video data.

Magnetic tape has heretofore been used as a data recording medium to record video data. Video data is managed by writing metadata on a label attached to a surface of a case of a magnetic tape.

In recent years, in the field of computers, large-capacity and randomly-accessible recording media such as hard disk drive and flash memory have been becoming mainstream data recording media.

Along with the increase in the capacities of data recording media, metadata such as title and description of what is recorded is becoming more and more important. Thus, how to handle metadata is becoming a topic to consider.

In the broadcasting industry, video servers have been developed which are capable of handling video data and its metadata.

In the broadcasting industry, there, are needs for managing video data and its metadata in the same medium. For this reason, there is often a case where metadata is added to recorded video data by use of video editing equipment.

In this case, the video editing equipment needs to follow editing steps of: reading a file of video data from a data recording medium; analyzing the file to detect a position where metadata should be embedded; creating a file in which the metadata is embedded at the detected position; and writing the file back to the data recording medium.

In general, broadcasting video data has a very large file size. Therefore, it takes an extremely long time to perform an editing process that includes for example: reading a file of video data from a data recording medium; analyzing the content of the file; deconstructing and editing the file; reconstructing the file; and writing the file back to the data recording medium.

Meanwhile, there has been proposed a method of embedding metadata in a broadcasting file in the course of converting recorded video data into the broadcasting file (see JP, P2009-296365A). In this method, however, the aforementioned editing steps have to be performed if metadata needs to be written additionally afterwards.

### BRIEF DESCRIPTION OF THE DRAWINGS

FIG. 1 shows the configuration of a video data processing system of an embodiment.

FIG. 2 shows an MXF file created by a file creation unit of the video data processing system.

FIG. 3 shows steps of writing new metadata onto an additional writing area in an already-created MXF file.

### DETAILED DESCRIPTION

A video file creation device according to an embodiment includes an encoder, a metadata acquisition unit, a file creation unit, and a data storage unit. The encoder is configured to create compressed video data from a video stream. The metadata acquisition unit is configured to acquire metadata related to the video data. The file creation unit configured to create a file in an MXF format having a metadata section formed of a metadata recording area and an additional writing area. The acquired metadata is recorded in the metadata recording area. The data storage unit configured to record the file in the MXF format created by the file creation unit.

Hereinbelow, an embodiment will be described by referring to the drawings.

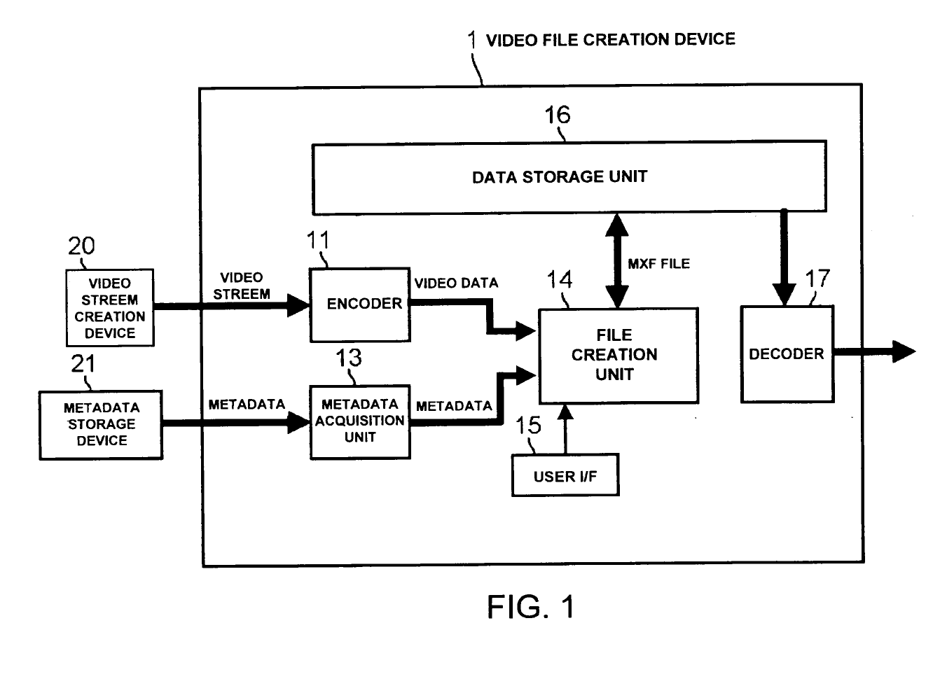

As shown in FIG. 1, a video data processing system includes a video file creation device 1, a video stream creation device 20, and a metadata storage device 21. The video stream creation device 20 is connected to the video file creation device 1 through a coaxial cable, and the metadata storage device 21 is connected to the video file creation device 1 through a communication cable or a network such as a LAN.

As the video stream creation device 20, a camera or a content server is available. The video stream creation device 20 is configured to store program content and send the program content requested to the video file creation device 1 in the form of a video stream.

The metadata storage device 21 is configured to store metadata which is management information associated with a program content stored in the video stream creation device 20.

The video file creation device 1 includes an encoder 11, a metadata acquisition unit 13, a file creation unit 14, a user interface 15 (hereinafter, referred to as “user I/F 15”), a data storage unit 16, and a decoder 17.

The encoder 11 is configured to send the video stream creation device 20 a request for video data and receive the corresponding video stream from the video stream creation device 20. The encoder 11 is also configured to compress the video stream in accordance with a video compression standard such as MPEG-2 or H.264 to thereby create compressed video data.

The metadata acquisition unit 13 is configured to acquire metadata related to a video stream (program content) from the metadata storage device 21.

The user I/F 15 includes input devices such as a keyboard and a mouse, and output devices such as a monitor to display a metadata edit screen. Through the user I/F 15, the user can specify a video stream to be read from the video stream creation device 20 and also specify metadata to be read from the metadata storage device 21. Moreover, through the user I/F 15, the user can specify metadata to be additionally written and parameters (the size of a metadata recording area, the size of an additional writing area, and the like) of an MXF file to be created by the file creation unit 14.

The data storage unit 16 is a storage device using a hard disk drive, for example. The data storage unit 16 is configured to store MXF files created by the file creation unit 14.

The decoder 17 is configured to read, when video data stored in the data storage unit 16 is to be broadcasted or played, a corresponding MXF file 30 from the data storage unit 16. The decoder 17 is also configured to extract the video data from the read MXF file 30 and output it in the form of a video stream to unillustrated broadcasting equipment or video playing equipment provided downstream of the decoder 17.

The file creation unit 14 has a function to create an MXF file in accordance with the MXF format. The file creation unit 14 converts video data created by the encoder 11 into an MXF file 30 in accordance with the MXF format, and writes this MXF file 30 onto the data storage unit 16.

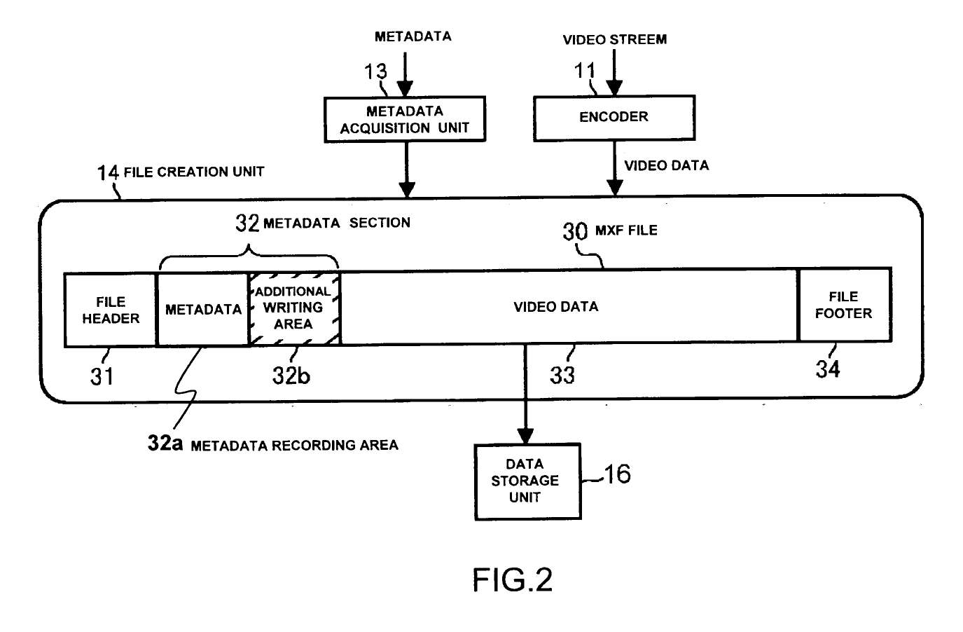

When creating the MXF file 30, the file creation unit 14 sets a metadata section 32 which is an area to record metadata, as shown in FIG. 2. This metadata section 32 has a metadata recording area 32a and an additional writing area 32b. Metadata acquired by the metadata acquisition unit 13 is recorded in the metadata recording area 32a whereas metadata written additionally afterwards is recorded in the additional writing area 32b.

The MXF standard is one of the formats of files for transmission to exchange the contents. As shown in FIG. 2, the MXF file 30 has a physically divided structure (i.e., partitions) which includes: a file header 31; the metadata section 32 in which metadata is embedded; a body 33 in which video data is embedded; and a file footer 34.

The file header 31 is positioned at the head of the file and indicates the structure of the file. Recorded in the file header 31 is link formation about locations (areas) where data pieces following the file header are recorded, respectively. The link information is associated with a key of each data piece. Whether or not the data piece at the corresponding location is rewritable is determined by the type of its key.

The metadata section 32 has the metadata recording area 32a where metadata acquired by the metadata acquisition unit 13 is recorded, and the additional writing area 32b where metadata written additionally afterwards is recorded. The additional writing area 32b is an area where data can be written on a separate, subsequent occasion, and is what is called an “empty area.” The file footer 34 is positioned at the tail of the file and indicates the end of the file.

Description will be given next of a case where new metadata is additionally written in an MXF file 30 that has been already created and stored in the data storage unit 16.

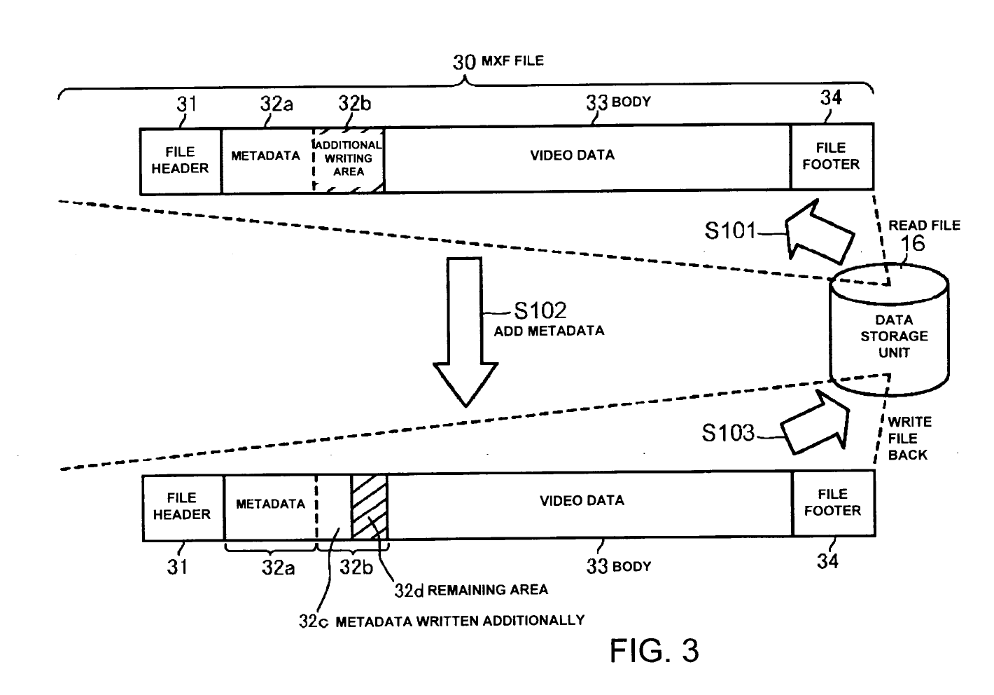

New metadata is inputted to the video file creation device 1 through the user I/F 15 and sent to the file creation unit 14. An MXF file 30 stored in the data storage unit 16 has a metadata section 32 formed of a metadata recording area 32a and an additional writing area 32b. As shown in FIG. 3, the file creation unit 14 reads the created MXF file 30 from the data storage unit 16 and writes additionally the new metadata onto the additional writing area 32b. Then, the file creation unit 14 writes the MXF file on which the new metadata has been written, back to the data storage unit 16.

To describe this in more detail, when the new metadata is to be additionally written into the created MXF file 30, the file creation unit 14 compares the size of the new metadata with the size of the additional writing area 32b.

If the size of the new metadata is smaller than the size of the additional writing area 32b, the file creation unit 14 writes the new metadata onto the additional writing area 32b and sets an area 32c where the new metadata is written as a write-protected area. The file creation unit 14 keeps a remaining area 32d in the additional writing area 32b as a new additional writing area. The remaining area 32d corresponds to the difference between the size of the additional writing area 32b and the size of the new metadata.

On the other hand, if the size of the new metadata is larger than the size of the additional writing area 32b, the file creation unit 14 expands the size of the additional writing area 32b to such an extent that the size of the additional writing area 32b becomes equal to the size of the new metadata. Then, the file creation unit 14 records the new metadata in the expanded additional writing area 32b. Note that the user may specify the size of the expanded additional writing area 32b through the user I/F 15 when he or she inputs the new metadata into the video data processing system through the user I/F 15. Moreover, the file creation unit 14 may store a predetermined expanded size as a default value in advance.

The file creation unit 14 then writes the MXF file in which the new metadata has been written, back to the data storage unit 16.

Description will be given below of one example of operations of the video data processing system of the embodiment. Referring to FIG. 1, in the video data processing system, contents of programs filmed with a television camera or the like are stored in the video stream creation device 20. In response to a request from the video file creation device 1, the video stream creation device 20 sends the requested program content to the video file creation device 1 in the form of a video stream.

In the video file creation device 1, upon receiving the video stream, the encoder 11 compresses the video stream in accordance with a video compression standard such as MPEG-2 or H.264. As a result, the video stream is converted into compressed video data, i.e., the video stream is encoded. The encoder 11 outputs the compressed video data to the file creation unit 14.

Meanwhile, the metadata storage device 21 stores therein metadata as management information associated with the program contents stored in the video stream creation device 20. The metadata acquisition unit 13 acquires metadata related to the aforementioned video stream (program content) from the metadata storage device 21 and outputs the acquired metadata to the file creation unit 14.

As shown in FIG. 2, the file creation unit 14 creates an MXF file 30 with the video data and the metadata corresponding to the video data in accordance with the MXF format. In this event, the file creation unit 14 sets a metadata section 32 having a metadata recording area 32a and an additional writing area 32b and writes the metadata acquired from the metadata storage unit 21 onto the metadata recording area 32a. Note that the file creation unit 14 may create a metadata section 32 of a predetermined size, set an area where the metadata is written as a metadata recording area 32a, and set the remaining area as an additional writing area 32b.

The file creation unit 14 then stores the created MXF file 30 into the data storage unit 16.

Description will be given next of a case of additionally writing new metadata into an MXF file 30 stored in the data storage unit 16, i.e., editing an MXF file 30. By specifying a file name through the user I/F 15, a metadata edit screen for editing new metadata to be additionally written is displayed on the monitor of the user I/F 15.

After new metadata targeting the specified MXF file 30 is inputted through the user I/F 15, the file creation unit 14 reads the MXF file 30 corresponding to the inputted name from the data storage unit 16, as shown in FIG. 3 (step S101).

Subsequently, the file creation unit 14 compares the size of the additional writing area 32b of the MXF file 30 with the size of the new metadata. If the size of the new metadata is smaller than the size of the additional writing area 32b, the file creation unit 14 writes the new metadata onto the additional writing area 32b (step S102), and sets the written area 32c as a write-protected area. The file creation unit 14 keeps the remaining area 32d as a new additional writing area on which any other metadata can be written. The remaining area 32d corresponds to the difference between the size of the additional writing area 32b and the size of the new metadata.

On the other hand, if the size of the new metadata is larger than the size of the additional writing area 32b, the file creation unit 14 expands the size of the additional writing area 32b to such an extent that the size of the additional writing area 32b becomes equal to the size of the new metadata. Then, the file creation unit 14 records the new metadata in the expanded additional writing area 32b.

The file creation unit 14 then writes the resultant MXF file 30 back to the data storage unit 16 (step S103).

As described above, according to the embodiment, the video file creation device creates an MXF file 30 by putting together video data of the content of a recorded program and metadata thereof. Moreover, the video file creation device sets an additional writing area 32b in a metadata section 32 of the MXF file 30. Thus, when new metadata needs to be written additionally afterwards into the MXF file 30, the new metadata can be additionally written onto the additional writing area 32b by simply reading the MXF file 30 without having to perform any file analysis or file reconstruction. Accordingly, the video file creation device of the embodiment can significantly reduce the operation time required to additionally write metadata into an already-created MXF file.

According to the embodiment, it is possible to provide a video file creation device and a video file creation method which can facilitate the additional writing of metadata into an already-created MXF file.

While the embodiment has been described, this embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

Note that each component described in the foregoing embodiment may be implemented by a program installed on a storage of a computer such as a hard disk drive. This program may be stored in a computer-readable electronic medium, and the program may be read from the electronic medium by a computer to thereby cause the computer to implement the function of the present invention. The electronic medium includes a storage medium such as a CD-ROM, as well as a flash memory, a removable medium, and the like, for example. Further, the components may be distributed and stored in different computers connected to each other through a network, and the computers functioning as the components may be caused to communicate with each other to thereby implement the function of the present invention.

What is claimed is:

1. A video file creation device comprising:
an encoder configured to create compressed video data from a video stream;
a metadata acquisition unit configured to acquire metadata related to the video data;
a file creation unit configured to create a file in an MXF format having a metadata section formed of a metadata recording area and an additional writing area, the acquired metadata being recorded in the metadata recording area; and
a data storage unit configured to record the file in the MXF format created by the file creation unit.
